(19) United States
(12) Patent Application Publication
(10) Pub. No.: US 2025/0303324 A1
(43) Pub. Date: Oct. 2, 2025

(54) GAS-LIQUID SEPARATOR WITH TWO-STAGE IMPACTION MEDIA

(71) Applicant: Cummins Filtration Inc., Nashville, TN (US)

(72) Inventors: Yubao Zhao, Wuhan City (CN); Alexis Orea Amador, Middleton, WI (US); Yuning Zhang, Wuhan (CN); Min Xu, Wuhan Hubei (CN); Qin Hu, Wuhan Hubei (CN)

(73) Assignee: Cummins Filtration Inc., Nashville, TN (US)

(21) Appl. No.: 18/912,215

(22) Filed: Oct. 10, 2024

(30) Foreign Application Priority Data
Mar. 29, 2024 (CN) 202410381081.8

(51) Int. Cl. B01D 19/00

(52) U.S. Cl. CPC B01D 19/0047; B01D 2201/31; B01D 2257/702; B01D 2258/01

(57) ABSTRACT

A gas-liquid separator includes a housing having a first housing portion defining a first housing volume and a second housing portion defining a second housing volume. The gas-liquid separator includes a plate positioned at least partially within the first housing volume. The gas-liquid separator includes a first impaction media positioned against the plate. The first impaction media extends in a first direction. The gas-liquid separator includes a second impaction media positioned against the plate. The second impaction media extends in a second direction, different than the first direction.

### CROSS-REFERENCE TO RELATED APPLICATIONS

The present application claims priority to Chinese Patent Application No. 202410381081.8, filed Mar. 29, 2024 and the contents of which are incorporated by referenced in its entirety.

### TECHNICAL FIELD

The present disclosure relates generally to the field of crankcase ventilation systems.

### BACKGROUND

During operation of an internal combustion engine, a fraction of combustion gases can flow out of the combustion cylinder and into the crankcase of the engine. These gases are often referred to as “blowby” gases. The blowby gases include a mixture of aerosols, oils, and air. The blowby gases are often routed out of the crankcase via a crankcase ventilation system. The crankcase ventilation system may pass the blowby gases through a coalescer (i.e., a coalescing filter element) or separator to remove most or all of the aerosols and oils contained in the blowby gases. The filtered blowby gases (“clean” gases) are then either vented to the ambient (in open crankcase ventilation systems) or routed back to the air intake for the internal combustion engine for further combustion (in closed crankcase ventilation systems).

One type of separator uses inertial impaction air-oil separation for removing oil particles from the crankcase blowby gas (or aerosol) by accelerating the blowby gas stream to high velocities through nozzles or orifices and directing same against an impactor, causing a sharp directional change effecting the oil separation.

### SUMMARY

Various embodiments provide for a gas-liquid separator. The gas-liquid separator includes a housing having a first housing portion defining a first housing volume and a second housing portion defining a second housing volume. The gas-liquid separator includes a plate positioned at least partially within the first housing volume. The gas-liquid separator includes a first impaction media positioned against the plate. The first impaction media extends in a first direction. The gas-liquid separator includes a second impaction media positioned against the plate. The second impaction media extends in a second direction, different than the first direction.

In some embodiments, the plate comprises: an end wall supporting the first impaction media; and a side wall extending away from the end wall towards the second housing portion, the side wall supporting the second impaction media.

In some embodiments, the plate further comprises an inner wall extending from the end wall and towards the second housing portion, the inner wall disposed radially inward from and spaced away from the side wall, the inner wall supporting the first impaction media.

In some embodiments, the plate further comprises a rib extending from the inner wall towards the second housing portion, the second impaction media retained between the rib and the side wall.

In some embodiments, the second housing portion comprises: an end wall disposed at a first end of the second housing portion; an outer wall extending away from the end wall and towards the first housing portion; and an inner wall extending away from the end wall and towards the first housing portion, the inner wall spaced away from the outer wall, such that a first chamber is defined by the end wall, an inner surface of the outer wall, and an outer surface of the inner wall, and a second chamber is defined by the end wall and an inner surface of the inner wall.

In some embodiments, the first direction is substantially perpendicular to the second direction.

In some embodiments, the plate is monolithically formed with the first housing portion.

In some embodiments, the first housing portion comprises: a housing wall; and a housing rib extending inward from the housing wall, into the first housing volume, the plate coupled to the housing rib.

Various other embodiments provide for a gas-liquid separator. The gas-liquid separator includes a housing having a first housing portion defining a first housing volume and a second housing portion defining a second housing volume, the second housing portion defining a second port structured to receive a blowby gas stream. The gas-liquid separator includes a first nozzle body positioned between the first housing portion and the second hosing portion. The gas-liquid separator includes a first nozzle coupled to the first nozzle body. The gas-liquid separator includes a plate positioned within the first housing volume. The gas-liquid separator includes a first impaction media positioned against the plate and spaced away from the one or more first nozzles by a first gap. The first impaction media extends in a first direction. The gas-liquid separator includes a second impaction media positioned against the plate and spaced away from the first nozzle body by a second gap. The second impaction media extends in a second direction, different than the first direction.

In some embodiments, the first nozzle body comprises: a first end wall; a first side wall extending away from the first end wall, towards the first housing portion, the second gap defined between the second impaction media and the first side wall; and a second end wall defining an opening sized to receive the first nozzle.

In some embodiments, the first nozzle body further comprises: a second side wall extending away from the second end wall, towards the first housing portion in an axial direction; and a nozzle body flange extending away from the second side wall, towards the first housing portion in a radial direction, the first gap defined between the first impaction media and the nozzle body flange.

In some embodiments, the plate comprises: an end wall supporting the first impaction media; and a side wall extending away from the end wall towards the first nozzle body, the side wall supporting the second impaction media.

In some embodiments, the plate further comprises an inner wall extending from the end wall and towards the first nozzle body, the inner wall disposed radially inward from and spaced away from the side wall, the inner wall supporting the first impaction media.

In some embodiments, the plate further comprises a rib extending from the inner wall towards the first nozzle body, the second impaction media retained between the rib and the side wall.

In some embodiments, the second housing portion comprises: an end wall disposed at a first end of the second housing portion; an outer wall extending away from the end wall and towards the first housing portion; and an inner wall extends away from the end wall and towards the first housing portion, the inner wall spaced away from the outer wall, such that a first chamber is defined by the end wall, an inner surface of the outer wall, and an outer surface of the inner wall, and a second chamber is defined by the end wall and an inner surface of the inner wall.

In some embodiments, the gas-liquid separator further comprises a second nozzle body disposed at a second end of the second housing portion, the second nozzle body comprising second nozzle configured to direct a fluid into the first nozzle.

In some embodiments, the gas-liquid separator defines an axis; the first direction is a radial direction, such that the first impaction media extends radially outward from the axis; and the second direction is an axial direction, such that the second impaction media extends circumferentially around and parallel to the axis.

In some embodiments, the first housing portion comprises: a housing wall; and one or more housing ribs extend inward from the housing wall, into the first housing volume, the plate coupled to the one or more housing ribs.

Various other embodiments provide for a media assembly for a gas-liquid separator. The media assembly includes a plate. The plate includes an end wall, an outer wall extending away from the end wall and spaced away from a center of the end wall, and an inner wall extending away from the end wall and spaced away from the center of the end wall and the outer wall. The media assembly includes a first media positioned against the end wall. The first media extends in a first direction. The media assembly includes a second media positioned against the outer wall and positioned between the outer wall and the inner wall. The second media extends in a second direction, different than the first direction.

In some embodiments, the plate further comprises one or more ribs extending away from the inner wall and parallel to the outer wall, the second media retained against the outer wall by the one or more ribs.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are, therefore, not to be considered limiting of its scope, the disclosure will be described with additional specificity and detail through use of the accompanying drawings.

FIG. 1 is a cross-sectional view of a gas-liquid separator system, according to an embodiment.

FIG. 2 is a cross-sectional view of a portion of a gas-liquid separator system, according to another embodiment.

Reference is made to the accompanying drawings throughout the following detailed description. In the drawings, similar symbols typically identify similar components unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION OF EMBODIMENT

Embodiments described herein relate to gas-liquid separators that include two impact media for separating liquids from a gas stream. A nozzle is used to accelerate blowby gas flow towards a first impaction media to facilitate separation of liquids and aerosols from the blowby gas stream. The embodiments described herein may also include an air jet to facilitate accelerating the gas stream through the nozzles. That is, the gas-liquid separators described herein may be or include a jet-assisted device.

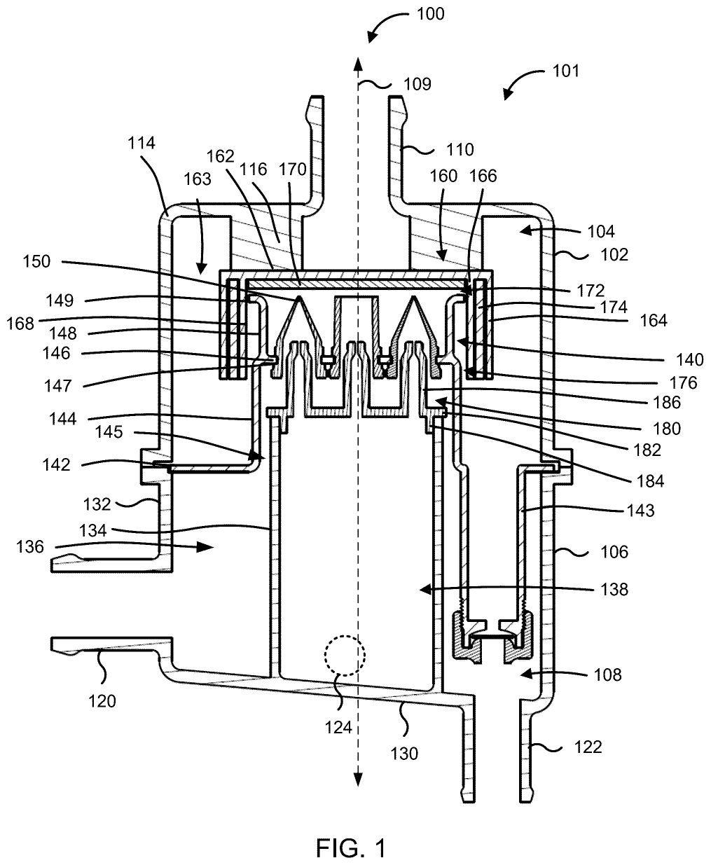

Referring to FIG. 1, side cross-sectional view of a gas-liquid separator 100 is shown, according to an embodiment. The gas-liquid separator 100 may be included in an open crankcase ventilation system or a closed crankcase ventilation system. The gas-liquid separator 100 is configured to separate a blowby gas stream into cleaned blowby gas and separated liquid, oil, gas, and/or aerosol (referred to herein as separated fluid).

The gas-liquid separator 100 includes a housing 101 having a first housing portion 102 defining a first housing volume 104 and a second housing portion 106 defining a second housing volume 108. The first housing portion 102 may be coupled to the second housing portion 106 (e.g., via securing members such as screws, nuts, bolts, rivets, etc.). A seal member (not shown) may be disposed between the first housing portion 102 and the second housing portion 106 so as to form a radial and/or axial seal therebetween.

In an example embodiment, the gas-liquid separator 100 defines an axis 109. One or more of the components of the gas-liquid separator 100 may be centered on the axis 109. The gas-liquid separator 100 can be centered on the valve axis 109. For example, the axis 109 extends through a center point of the gas-liquid separator 100.

As used herein, the term “axis” describes a theoretical line extending through at least a portion of an object, such as a centroid (e.g., center of mass, geometric center, etc.) of an object. In some arrangements, the object is centered on the axis. The object is not necessarily cylindrical (e.g., a non-cylindrical shape may be centered on an axis, etc.). Furthermore, the object is not necessarily on the axis (e.g., a centroid of a hollow object may be on the axis, but no portion of the object needs to be on the axis).

The relative positioning of the components of the gas-liquid separator 100 described herein may be described relative to the axis 109. For example, an axial direction is along or substantially parallel to the axis 109. A radial direction may be defined as a direction that is substantially perpendicular to the axial direction. A radial outward direction may be substantially away from the axis 109. A radial inward direction may be substantially towards the axis 109. A circumferential direction may be defined as a direction along a theoretical circle centered on the axis 109. A tangential direction may be defined as a direction along a theoretical tangent line of the theoretical circle centered on the axis 109.

The first housing portion 102 includes a first port 110. In the embodiment shown in FIG. 1, the first port 110 is an outlet port. For example, the first port 110 is structured to receive the cleaned blowby gas (e.g., “clean” blowby air) from the first housing volume 104 and communicate the cleaned blowby gas to a downstream component, such as an air intake in a closed crankcase ventilation system or to the atmosphere in an open crankcase ventilation system.

The first housing portion 102 includes a housing wall 114. The housing wall 114 at least partially defines the first housing volume 104. The first housing portion 102 includes one or more housing ribs 116 (e.g., a first housing rib, a second housing rib, etc.). The one or more housing ribs 116 extend inward from the housing wall 114, into the first housing volume 104. The one or more housing ribs 116 extend away from the housing wall 114, towards the second housing portion 106.

The second housing portion 106 includes a second port 120, a third port 122, and a fourth port 124. In the embodiment shown in FIG. 1, the second port 120 is an inlet port. The second port 120 is structured to receive a blowby gas stream and communicate the blowby gas stream into the second housing volume 108. The third port 122 is an outlet port. The third port 122 is structured to receive the separated fluid and communicate the separated fluid to a downstream component, such as an oil sump or other suitable component. The fourth port 124 is an inlet port. The fourth port is structured to receive an air stream and communicate the air stream into the second housing volume 108.

The second housing portion 106 includes an end wall 130, an outer wall 132, and an inner wall 134. The end wall 130 is disposed at a first end of the second housing portion 106. The third port 122 extends through the end wall 130. The outer wall 132 extends away from the end wall 130 and towards the first housing portion 102. The second port 120 extends through the outer wall 132. The inner wall 134 extends away from the end wall 130 and towards the first housing portion 102. The inner wall 134 is spaced away from the outer wall 132. The inner wall 134 may extend at least partially into the first housing volume 104. The fourth port 124 extends through the outer wall 132 and the inner wall 134. A first chamber 136 is defined by the end wall 130, an inner surface of the outer wall 132, and an outer surface of the inner wall 134. A second chamber 138 is defined by the end wall 130 and an inner surface of the inner wall 134.

The second housing portion 106 is structured to receive the blowby gas stream at the first chamber 136 (e.g., via the second port 120). The second housing portion 106 is structured to receive the air stream at the second chamber 138 (e.g., via the fourth port 124).

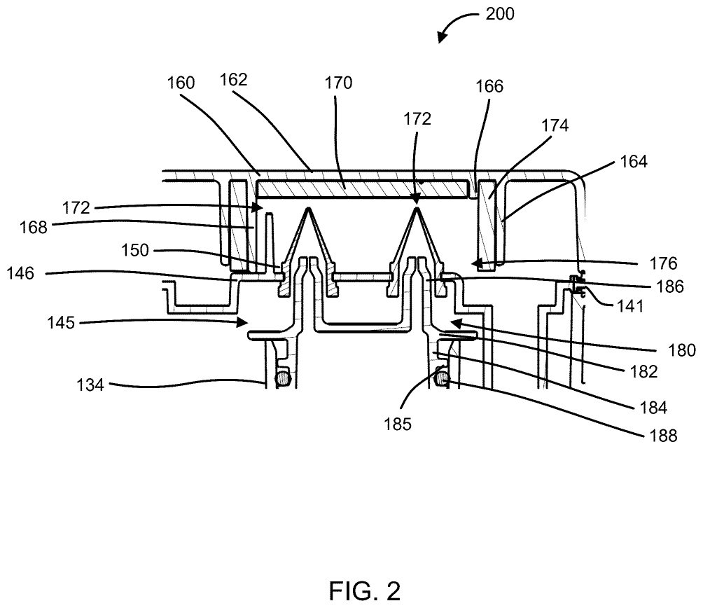

The gas-liquid separator includes a first nozzle body 140. The first nozzle body 140 is disposed at least partially within the first housing volume 104 and at least partially within the second housing volume 108. In some embodiments, and as shown in FIG. 2, a seal member 141 may be disposed around a portion the first nozzle body 140. The seal member 141 may extend between the first housing portion 102 and the second housing portion 106 so as to form a radial and/or axial seal therebetween.

In some embodiments, the first nozzle body 140 is removably coupled to the housing 101. For example, the first nozzle body 140 may be coupled to one or both of the first housing portion 102 and the second housing portion 106. In these embodiments, the first nozzle body 140 may be serviced (e.g., repaired and/or replaced) without damaging the other components of the gas-liquid separator 100.

The first nozzle body 140 includes a first end wall 142. The first end wall 142 is disposed between the first housing portion 102 and the second housing portion 106 such that the first end wall 142 separates the first housing volume 104 and the second housing volume 108. The first end wall 142 extends in a radial direction, relative to the axis 109. The first end wall 142 defines an opening 145 extending through the center or proximate the center of the first end wall 142.

The first nozzle body 140 includes a nozzle body port 143. The nozzle body port 143 extends through the first end wall 142 and towards the second housing portion 106. The nozzle body port 143 extends into the second housing volume 108. The nozzle body port 143 extends into the first chamber 136. The nozzle body port 143 is configured to enable fluid communication between the first housing volume 104 and the second housing volume 108. In an example embodiment, a fluid, such as the separated fluid, flows from the first housing volume 104, through the nozzle body port 143, and into the second housing volume 108.

The first nozzle body 140 includes a first side wall 144. The first side wall 144 extends away from the end wall 182 and towards the first housing portion 102 in the axial direction. The first side wall 144 is disposed at or proximate a center of the first end wall 142 such that the first end wall 142 extends radially outward from the first side wall 144. The first side wall 144 is disposed at the perimeter of the opening 145. The first side wall 144 is substantially perpendicular to the first end wall 142. The first side wall 144 is spaced radially away from a center point of the first end wall 142.

The first nozzle body 140 includes a second end wall 146. The second end wall 146 extends radially inward from the first side wall 144 to a center point of the second end wall 146. The second end wall 146 is spaced away from the first end wall 142. The second end wall 146 is substantially parallel to the first end wall 142. In some embodiments, the second end wall 146 defines one or more openings 147. The one or more openings 147 are sized to receive a nozzle 150. The nozzles 150 are described in greater detail herein below.

The first nozzle body 140 includes a second side wall 148. The second side wall 148 extends away from the second end wall 146 and towards the first housing portion 102 in the axial direction. The second side wall 148 is disposed at or proximate an outer circumference of the second end wall 146. The one or more openings 147 are disposed radially inward from the second side wall 148. The second side wall 148 is substantially perpendicular to the second end wall 146. The second side wall 148 is spaced radially away from the first side wall 144.

The first nozzle body 140 includes a nozzle body flange 149. The nozzle body flange 149 extends radially away from the second side wall 148, towards the first housing portion 102. The nozzle body flange 149 extends in a radial direction. The nozzle body flange 149 extends away from the axis 109. The nozzle body flange 149 is disposed at a first axial end of the second side wall 148. The second end wall 146 is disposed at a second axial end of the second side wall 148, opposite the first axial end. The second side wall 148 extends between the second end wall 146 and the nozzle body flange 149.

The gas-liquid separator 100 includes the one or more nozzles 150 (e.g., one or more first nozzles 150, a first nozzle 150, etc.). In some embodiments, nozzles 150 may be “duckbill” nozzles. In some embodiments, a “duckbill” nozzle can refer to an elastomeric nozzle that is shaped to resemble a duck's bill. As shown, the nozzles 150 have a duck billed shape. The nozzle may expand and contract in response to a pressure change and maintains higher velocity for higher efficiency compared to standard nozzles.

The nozzles 150 are in series with and downstream of the second port 120 such that the nozzles 150 receive a blowby gas stream from the second port 120. The nozzles 150 are positioned along the fluid flow path of the blowby gas stream between the second port 120 and the first housing volume 104. The nozzles 150 may be mounted on or fluidly coupled to the first nozzle body 140 (e.g., at the openings 147). The nozzles 150 are each disposed within a corresponding opening 147. The nozzles 150 extend away from the openings 147 in an axial direction and towards a plate 160 (described herein below). The nozzles 150 are configured communicate the blowby gas stream downstream of the second port 120, into the first housing volume 104, and at the plate 160.

As briefly described above, each nozzle 150 may be positioned in a corresponding opening 147 of the first nozzle body 140. That is, the first nozzle body 140 is configured to receive the nozzles 150. The nozzles 150 may be coupled to the first nozzle body 140. The nozzles 150 are structured to direct a fluid, such as a blowby gas stream, an air stream, etc., towards the first housing portion 102.

The opening 145 in the first nozzle body 140 enables fluid communication between the second housing volume 108 and the nozzles 150. The opening 145 in the first nozzle body 140 enables fluid communication between the first chamber 136 and the nozzles 150. That is a fluid can flow from the second housing volume 108, or, more specifically, the first chamber 136, through the opening 145, and into the nozzles 150.

The gas-liquid separator 100 includes the plate 160. In some embodiments, and as shown in FIG. 1, the plate 160 is coupled to the housing 101. In these embodiments, the plate 160 is coupled to the first housing portion 102. More specifically, the plate 160 may contact and be coupled to the one or more ribs 116.

In some embodiments, and as shown in FIG. 2, the plate 160 is monolithically formed with the first housing portion 102. The plate 160 is disposed at least partially within the first housing volume 104.

The plate 160 includes an end wall 162. The end wall 162 is disposed within the first housing volume 104. The end wall 162 extends in a radial direction relative to the axis 109. The end wall 162 extends outward from the axis 109, towards the housing wall 114. The end wall 162 is spaced away from the housing wall 114 in the radial direction, such that a gap 163 is defined between the end wall 162 and the housing wall 114.

The plate 160 includes a side wall 164 that extends from the end wall 162 and towards the first nozzle body 140, in the axial direction. The side wall 164 is disposed around an outer perimeter of the end wall 162. The side wall 164 is substantially perpendicular to the first end wall 162. The side wall 164 is spaced radially away from a center point of the first end wall 162.

The plate 160 includes an inner wall 166. The inner wall 166 extends from the end wall 162 and towards the first nozzle body 140, in the axial direction. The inner wall 166 is disposed radially inward from the side wall 164. The inner wall 166 is spaced away from the side wall 164. The inner wall 166 is substantially parallel to the side wall 164. The inner wall 166 is spaced radially away from a center point of the first end wall 162.

The plate 160 includes one or more plate ribs 168 (e.g., a first plate rib, a second plate rib, etc.). The one or more plate ribs 168 extend away from the inner wall 166 and towards the first nozzle body 140, in the axial direction. The plate ribs 168 are disposed radially inward from the side wall 164. The plate ribs 168 are spaced away from the side wall 164. The plate ribs 168 are substantially parallel to the side wall 164. The plate ribs 168 is spaced radially away from a center point of the first end wall 162.

The gas-liquid separator 100 includes a first impaction media 170. The first impaction media 170 is positioned against the plate 160. The first impaction media 170 is positioned against the plate 160 at the first end wall 162. The first end wall 162 supports the first impaction media 170. In some embodiments, the first impaction media 170 is positioned against the plate 160 at the inner wall 166. The inner wall 166 supports the first impaction media 170.

In some embodiments, the first impaction media 170 is coupled to the plate 160. The first impaction media 170 is coupled to the plate 160 at the first end wall 162. In some embodiments, the first impaction media 170 is coupled to the plate 160 at the inner wall 166. In some embodiments, the first impaction media 170 is coupled to the plate 160 via an adhesive.

The first impaction media 170 is substantially parallel to the first end wall 162. The first impaction media 170 is disc shaped. The first impaction media 170 extends radially outward from the axis 109. The first impaction media 170 extends in a first direction. The first direction may be along a plane that is perpendicular to a flow direction of the blowby gas stream flowing out of the nozzles 150.

The first impaction media 170 is disposed downstream of the nozzles 150 and in a direct flow path of the blowby gas stream flowing from the nozzles 150. That is, the nozzles 150 are structured to direct the blowby gas stream towards the first impaction media 170. The first impaction media 170 defines a flat surface (that the blowby gas stream impacts) that extends along a plane that is at an angle of about 90 degrees with respect to a direction of flow of the blowby gas flow streams flowing out from the nozzles 150.

In various embodiments, the first impaction media 170 is spaced away from the nozzles 150 such that a gap 172 is formed between the first impaction media 170 and the nozzles 150. A width of the gap 172 is non-zero such that the first impaction media 170 is spaced away from the nozzles 150. The gap 172 is also defined between the first impaction media 170 and the nozzle body flange 149.

In some embodiments, the first impaction media 170 is spaced away from the nozzle body flange 149 such that the gap 172 is defined between the first impaction media 170 and the nozzle body flange 149. A width of the gap 172 is non-zero such that the first impaction media 170 is spaced away from the nozzle body flange 149.

The gas-liquid separator 100 includes a second impaction media 174. The second impaction media 174 is positioned against the plate 160. The second impaction media 174 is positioned against the plate 160 at the side wall 164.

In some embodiments, the second impaction media 174 is coupled to the plate 160. The second impaction media 174 is coupled to the plate 160 at the side wall 164. In some embodiments, the second impaction media 174 is coupled to the plate 160 via an adhesive.

In some embodiments, the side wall 164 supports the second impaction media 174. The second impaction media 174 is retained against the side wall 164 by at least one of the one or more plate ribs 168.

The second impaction media 174 has an annular cross-sectional shape. The second impaction media 174 extends circumferentially around the axis 109. The second impaction media 174 is substantially parallel to the side wall 164. The second impaction media 174 extends in a second direction, different than the first direction. The second direction may be perpendicular to the first direction.

The second impaction media 174 is disposed downstream of the nozzles 150 and downstream of the first impaction media 170. That is, the blowby gas stream flows through the nozzles 150, into the first impaction media 170. The blowby gas stream then flows from the first impaction media 170, into the second impaction media 174. The second impaction media 174 defines an inner surface (that the blowby gas stream impacts) that extends in an axial direction that is at an angle of about 90 degrees with respect to the plane of the first impaction media 170 and around a circumference centered at the axis 109.

In some embodiments, the second impaction media 174 is spaced away from the nozzle body flange 149 such that a gap 176 is defined between the second impaction media 174 and the nozzle body flange 149. A width of the gap 176 is non-zero such that the second impaction media 174 is spaced away from the nozzle body flange 149.

In some embodiments, the second impaction media 174 is spaced away from the first side wall 144 of the first nozzle body 140, such that the gap 172 is formed between the second impaction media 174 and the nozzles 150. A width of the gap 172 is non-zero such that the first impaction media 170 is spaced away from the nozzles 150.

The gas-liquid separator 100 includes a second nozzle body 180. The second nozzle body 180 is disposed at least partially within the first housing volume 104. The second nozzle body 180 is disposed at a second end of the second housing portion 106, opposite the first end. In some embodiments, and as shown in FIG. 2, a seal member 188 may be disposed around a portion the second nozzle body 180. The seal member 188 is positioned between the second nozzle body 180 and the inner wall 134 so as to form a radial seal therebetween.

In some embodiments, the second nozzle body 180 is removably coupled to the housing 101. For example, the second nozzle body 180 may be coupled to the second housing portion 106. In these embodiments, the second nozzle body 180 may be serviced (e.g., repaired and/or replaced) without damaging the other components of the gas-liquid separator 100.

The second nozzle body 180 includes a first end wall 182. The first end wall 182 is disposed at a first end of the inner wall 134. The first end wall 182 extends in a radial direction, relative to the axis 109.

The second nozzle body 180 includes a first side wall 184. The first side wall 184 extends away from the first end wall 182. The first side wall 184 extends towards the second housing portion 106. The first side wall 184 extends in an axial direction, relative to the axis 109. In some embodiments, the first side wall 184 defines a sealing surface, shown as a sealing channel 185 in FIG. 2. The sealing channel 185 is configured to receive at least a portion of the seal member 188 therein.

The second nozzle body 180 includes one or more nozzles 186 (e.g., one or more second nozzles 186, a second nozzle 186, etc.). The nozzles 186 extends through the first end wall 182 and towards the first housing portion 102. The nozzles 186 is configured to enable fluid communication between the second chamber 138 and the nozzles 150. For example, each of the one or more second nozzles 186 is configured to direct a fluid into a respective one of the one or more first nozzles 150. The one or more nozzles 186 may be configured to increase a speed of a fluid flowing therethrough. In an example embodiment, a fluid, such as an air stream, flows from the fourth port 124, into the second chamber 138, through the nozzles 186, and into the nozzles 150. In some embodiments, the nozzles 186 extend at least partially into a downstream side of the nozzles 150. In some embodiments, each nozzle 186 has a corresponding nozzle 150.

Now referring to FIG. 2, a cross-sectional view of a portion of a gas-liquid separator 200 is shown, according to another embodiment. The gas-liquid separator 200 shown in FIG. 2 is substantially similar to or the same as the gas-liquid separator 100 shown in FIG. 1. Furthermore, like numbering is used in FIG. 2 relative to FIG. 1, except where differences are noted. Thus, it should be understood that like numbering refers to like features that are substantially similar to or the same. The various differences are described herein below. However, it should be understood that the embodiments described herein with respect to FIGS. 1 and 2 are not mutually exclusive and may be combined.

In some embodiments, the gas-liquid separator 200 includes the seal member 141. The seal member 141 may be disposed around a portion the first nozzle body 140. The seal member 141 may extend between the first housing portion 102 and the second housing portion 106 so as to form a radial and/or axial seal therebetween.

In some embodiments, the gas-liquid separator 200 includes the plate 160. The plate 160 of the gas-liquid separator 200 is monolithically formed with the first housing portion 102. The plate 160 is disposed at least partially within the first housing volume 104.

In some embodiments, the gas-liquid separator 200 includes the seal member 188. The seal member 188 may be disposed around a portion the second nozzle body 180. The seal member 188 is positioned between the second nozzle body 180 and the inner wall 134 so as to form a radial seal therebetween.

In some embodiments, the first side wall 184 of the second nozzle body 180 of the gas-liquid separator 200 defines a sealing surface, shown as the sealing channel 185. The sealing channel 185 is configured to receive at least a portion of the seal member 188 therein.

In operation, the gas-liquid separator 100 receives a blowby gas stream (e.g., from a crankcase of an engine) at the second port 120. The first port 120 directs the blowby gas stream to flow into the first chamber 136. The blowby gas stream flows from the first chamber 136, through the opening 145, and into the nozzles 150. The nozzles 150 directed the blowby gas stream into the first impaction media 170. In some embodiments, an air stream enters the second chamber 138 via the fourth port 124. The air stream flows from the second chamber 138, through the nozzles 186, and into the nozzles 150. As the air stream flows through the nozzles 150, the air stream accelerates (e.g., increases the speed of) the blowby gas stream flowing through the nozzles 150. As the blowby gas stream exits the nozzles 150, the blowby gas stream crosses the first gap 172 and impacts the first impaction media 170, which at least partially separates the blowby gas stream into cleaned blowby gas and separated fluid. The at least partially separated blowby gas stream then flows radially outward (e.g., away from the axis 109) and towards the second impaction media 174. The at least partially separated blowby gas stream impacts the second impaction media 174, which further separates the blowby gas stream into cleaned blowby gas and separated fluid. The cleaned blowby gas and the separated fluid then flows through the gap 176, and into the first housing volume 104. It should be understood that the above-described embodiments may be applicable to the gas-liquid separator 100 and/or the gas-liquid separator 200.

Advantageously, in various embodiments the first impaction media 170 and the second impaction media 174 reduces the amount of contaminants (e.g., oil, fuel, aerosols, etc.) in the cleaned blowby gas stream. For example, a larger portion of the contaminants in the blowby gas may be separated from the cleaned blowby gas by the first impaction media 170 and the second impaction media 174. The velocity of the blowby gas stream may not significantly decrease due to impacting the first impaction media 170. The momentum of the blowby gas stream allows the blowby gas stream to impact the second impaction media 174.

Furthermore, according to various embodiments the first gap 172 and the second gap 176 cooperate to advantageously force the blowby gas stream to flow from the first impaction media 170, towards the second impaction media 174, and from the second impaction media 174, into the first housing volume 104. Advantageously, the first gap 172 and the second gap 176 enable the flow of the blowby gas stream without significantly decreasing the pressure. Thus, the combination of two impaction media (e.g., the first impaction media 170 and the second impaction media 174) and the first gap 172 and the second gap 176 enable improved cleaning of the blowby gas stream without significantly decreasing the pressure of the blowby gas stream.

The cleaned blowby gas may flow from the first housing volume 104, through the first port 110, and out of the gas-liquid separator 100. In some embodiments, the cleaned blowby gas is vented to the ambient (e.g., in an open crankcase ventilation system). In other embodiments, the cleaned blowby gas is routed to an air intake of the internal combustion engine for further combustion (e.g., in closed crankcase ventilation systems).

At least a portion of the separated fluid (e.g., oil) flows from the first impaction media 170 and the second impaction media 174 and towards the first end wall 142. The portion of the separated fluid may flow into the nozzle body port 143, through the third port 122, and to a downstream component, such as an oil sump or other suitable component.

As used herein, the term “about” generally means plus or minus 10% of the stated value. For example, about 0.5 would include 0.45 and 0.55, about 10 would include 9 to 11, about 1000 would include 900 to 1100.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

As utilized herein, the term “substantially” and any similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided unless otherwise noted. Accordingly, these terms should be interpreted as indicating that insubstantial or inconsequential modifications or alterations of the subject matter described and claimed are considered to be within the scope of the invention as recited in the appended claims.

The terms “coupled” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the embodiments described herein.

While this specification contains many specific implementation details, these should not be construed as limitations on the scope of any embodiment or of what may be claimed, but rather as descriptions of features specific to particular implementations of particular embodiments. Certain features described in this specification in the context of separate implementations can also be implemented in combination in a single implementation.

Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A gas-liquid separator comprising:
a housing having a first housing portion defining a first housing volume and a second housing portion defining a second housing volume;
a plate positioned at least partially within the first housing volume;
a first impaction media positioned against the plate, the first impaction media extending in a first direction; and
a second impaction media positioned against the plate, the second impaction media extending in a second direction, different than the first direction.

2. The gas-liquid separator of claim 1, wherein the plate comprises:
an end wall supporting the first impaction media; and
a side wall extending away from the end wall towards the second housing portion, the side wall supporting the second impaction media.

3. The gas-liquid separator of claim 2, wherein the plate further comprises an inner wall extending from the end wall and towards the second housing portion, the inner wall disposed radially inward from and spaced away from the side wall, the inner wall supporting the first impaction media.

4. The gas-liquid separator of claim 3, wherein the plate further comprises a rib extending from the inner wall towards the second housing portion, the second impaction media retained between the rib and the side wall.

5. The gas-liquid separator of claim 1, wherein the second housing portion comprises:
an end wall disposed at a first end of the second housing portion;
an outer wall extending away from the end wall and towards the first housing portion; and
an inner wall extending away from the end wall and towards the first housing portion, the inner wall spaced away from the outer wall, such that a first chamber is defined by the end wall, an inner surface of the outer wall, and an outer surface of the inner wall, and a second chamber is defined by the end wall and an inner surface of the inner wall.

6. The gas-liquid separator of claim 1, wherein the first direction is substantially perpendicular to the second direction.

7. The gas-liquid separator of claim 1, wherein the plate is monolithically formed with the first housing portion.

8. The gas-liquid separator of claim 1, wherein the first housing portion comprises:
a housing wall; and
a housing rib extending inward from the housing wall, into the first housing volume, the plate coupled to the housing rib.

9. A gas-liquid separator comprising:
a housing having a first housing portion defining a first housing volume and a second housing portion defining a second housing volume, the second housing portion defining a second port structured to receive a blowby gas stream;
a first nozzle body positioned between the first housing portion and the second hosing portion;
a first nozzle coupled to the first nozzle body;
a plate positioned within the first housing volume;
a first impaction media positioned against the plate and spaced away from the first nozzle by a first gap, the first impaction media extending in a first direction; and
a second impaction media positioned against the plate and spaced away from the first nozzle body by a second gap, the second impaction media extending in a second direction, different than the first direction.

10. The gas-liquid separator of claim 9, wherein the first nozzle body comprises:
a first end wall;
a first side wall extending away from the first end wall, towards the first housing portion, the second gap defined between the second impaction media and the first side wall; and
a second end wall defining an opening sized to receive the first nozzle.

11. The gas-liquid separator of claim 10, wherein the first nozzle body further comprises:
a second side wall extending away from the second end wall, towards the first housing portion in an axial direction; and
a nozzle body flange extending away from the second side wall, towards the first housing portion in a radial direction, the first gap defined between the first impaction media and the nozzle body flange.

12. The gas-liquid separator of claim 9, wherein the plate comprises:
an end wall supporting the first impaction media; and
a side wall extending away from the end wall towards the first nozzle body, the side wall supporting the second impaction media.

13. The gas-liquid separator of claim 12, wherein the plate further comprises an inner wall extending from the end wall and towards the first nozzle body, the inner wall disposed radially inward from and spaced away from the side wall, the inner wall supporting the first impaction media.

14. The gas-liquid separator of claim 13, wherein the plate further comprises a rib extending from the inner wall towards the first nozzle body, the second impaction media retained between the rib and the side wall.

15. The gas-liquid separator of claim 9, wherein the second housing portion comprises:
an end wall disposed at a first end of the second housing portion;
an outer wall extending away from the end wall and towards the first housing portion; and
an inner wall extends away from the end wall and towards the first housing portion, the inner wall spaced away from the outer wall, such that a first chamber is defined by the end wall, an inner surface of the outer wall, and an outer surface of the inner wall, and a second chamber is defined by the end wall and an inner surface of the inner wall.

16. The gas-liquid separator of claim 9, further comprising a second nozzle body disposed at a second end of the second housing portion, the second nozzle body comprising second nozzle configured to direct a fluid into the first nozzle.

17. The gas-liquid separator of claim 9, wherein:
the gas-liquid separator defines an axis;
the first direction is a radial direction, such that the first impaction media extends radially outward from the axis; and
the second direction is an axial direction, such that the second impaction media extends circumferentially around and parallel to the axis.

18. The gas-liquid separator of claim 9, wherein the first housing portion comprises:
a housing wall; and
one or more housing ribs extend inward from the housing wall, into the first housing volume, the plate coupled to the one or more housing ribs.

19. A media assembly for a gas-liquid separator comprising:
a plate comprising:
an end wall,
an outer wall extending away from the end wall and spaced away from a center of the end wall, and
an inner wall extending away from the end wall and spaced away from the center of the end wall and the outer wall;
a first media positioned against the end wall, the first media extending in a first direction; and
a second media positioned against the outer wall and positioned between the outer wall and the inner wall, the second media extending in a second direction, different than the first direction.

20. The media assembly of claim 19, wherein the plate further comprises one or more ribs extending away from the inner wall and parallel to the outer wall, the second media retained against the outer wall by the one or more ribs.
